(19) United States
(12) Patent Application Publication
(10) Pub. No.: US 2010/0171754 A1
(43) Pub. Date: Jul. 8, 2010

(54) CONVERTING DIGITAL INK TO SHAPES AND TEXT

(75) Inventors: Larry Tucker Hatfield, Bothell, WA (US); Thomas Peter Russo, Seattle, WA (US); Sashi Raghupathy, Redmond, WA (US); Manoj Kumar Biswas, Bellevue, WA (US); Crystal Lynn Hoyer, Seattle, WA (US); Ming Ye, Bellevue, WA (US); Ivan Stojiljkovic, (US); Thomas Charles Underhill, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/349,517

(22) Filed: Jan. 7, 2009

(51) Int. Cl. G06T 11/20; G06T 11/00; G09G 5/00

(52) U.S. Cl. 345/619; 345/441; 345/467

(57) ABSTRACT

A shape expressed using digital ink is recognized and a beautified shape is inserted into a document in a native document format. A user interface (“UI”) control is displayed adjacent to the beautified shape which, when selected, will display selectable items for modifying the beautified shape. Insertion of the beautified shape may be undone, the beautified shape may be deleted, and the format of the beautified shape may be modified. Digital ink may also be received that corresponds to text. The digital ink is inserted into a document, displayed, and the text represented by the digital ink is recognized. A UI control is displayed adjacent to the digital ink that will display one or more selectable UI items corresponding to recognition alternates. When selected, the selectable items will cause the text of the corresponding recognition alternate to be inserted into the document.

### BACKGROUND

Many types of application programs provide functionality for inserting a shape into a document. For instance, a presentation program may provide functionality for browsing a gallery of shapes and for inserting one of the shapes in the gallery into a presentation document. Geometric shapes like squares, rectangles, circles, and triangles, flowchart shapes, lines, block lines, callouts, and virtually any other type of shape may be inserted into a document using this functionality.

In many implementations, it is necessary for a user to make multiple selections with a user input device in order to insert a shape into a document. For instance, in one implementation, a user must navigate to a portion of a user interface for inserting a shape, make a user input selection to display the available shapes, select one of the available shapes, place the shape on the document canvas, and specify the desired size and rotation for the shape. While not overly burdensome, the extended sequence of steps necessary to insert a shape into a document using previous user interfaces can be frustrating for users of computers having non-traditional user input devices, such as pen-based tablet or touch screen computers.

It is with respect to these considerations and others that the disclosure made herein is presented.

### SUMMARY

Technologies are described herein for converting digital ink to shapes and text. In particular, through an implementation of the concepts and technologies presented herein, shapes can be inserted into a document in a simplified manner as compared to previous solutions, particularly when a pen-based tablet or touch screen computer is utilized.

According to one embodiment presented herein, a computing system is provided that includes functionality for inserting a shape into a document utilizing digital ink. As used herein, the term “digital ink” refers to one or more strokes that are recorded from a digitizer, such as pointing device like a mouse, a digitizer tablet, or a display screen integrated with a digitizer tablet (e.g., a touch-sensitive display screen). By drawing a freeform shape directly into a document using digital ink, as opposed to selecting a shape from a gallery of shapes, a shape can be more quickly inserted into the document in the desired manner.

According to one aspect, a user may utilize a digitizer to provide digital ink for insertion into a document. Upon receiving the digital ink, the digital ink is inserted into the document and displayed. Additionally, the digital ink is provided to a recognition and conversion engine that is capable of identifying the shape, or shapes if there is ambiguity, that the digital ink corresponds to. For instance, a user may draw an approximate square using a pen and a digitizer tablet. The recognition and conversion engine can receive the digital ink, recognize that the digital ink corresponds to a square, and provide a geometrically correct representation of the shape, referred to herein as a beautified shape. As an example, although the approximate square drawn by the user would most likely have jagged lines of unequal length, the beautified square would have four straight lines of exactly the same length.

In one implementation, the recognition engine returns a recognized shape. In response to receiving the recognized shape, a beautified shape is identified based on the recognized shape and is inserted into the document in place of the digital ink. The beautified shape is displayed after the recognition and conversion engine has returned the recognized shape. In another embodiment, a user may be permitted to select one of a number of possible shapes for insertion into the document after the recognition and conversion engine has performed the recognition operation on the digital ink.

In one implementation, the beautified shape is stored in a native application format utilized for representing shapes. For instance, the beautified shape may be stored in the same application format that is utilized to store shapes made available for insertion into a document through a shape gallery or other type of user interface. In this manner, any operations that may be performed on shapes may also be performed on the beautified shapes inserted into a document in the manner presented herein.

In one embodiment, a user interface (“UI”) control, referred to herein as the “correction UI”, is displayed adjacent to the beautified shape. When selected, the correction UI is configured to display one or more selectable items which, when selected, will modify the beautified shape. For instance, in one implementation, the selection of one of the selectable items will cause the digital ink to be re-inserted into the document in place of the beautified shape. One of the selectable UI items might also cause the beautified shape to be deleted from the document when selected. If the recognition and conversion engine returns two or more alternate beautified shapes it determines the ink may represent, selectable items may be displayed that correspond to the shapes. Selection of one of these selectable items will cause the beautified shape corresponding to the selected item to be inserted into the document.

According to other embodiments, selectable items might also be selectively provided that modify the formatting of the beatified shape. For instance, if the beautified shape is a square or rectangle, a selectable item might be provided which, when selected, will cause the corners of the square or rectangle to be rounded. If the beautified shape is a straight line arrow, a selectable item might be provided for causing the straight line arrow to be replaced with a block arrow. A selectable item might also be provided which, when selected, will cause a user interface to be provided for setting options relating to the correction UI, such as when and how the UI is displayed.

According to another embodiment, digital ink may be received that corresponds to text content. In this case, the digital ink will be inserted into the document and displayed. The digital ink is then provided to the recognition and conversion engine. In response, the recognition and conversion engine will recognize text within the digital ink and return one or more recognition alternates. Recognition alternates represent the various text words or phrases that might be represented by the digital ink. For instance, a user may write the word “test” using digital ink. In this case, the recognition alternates may include the words “test”, “text”, “toast”, and “twist.”

Once the recognition alternates have been received, a UI control, referred to herein as the “confirmation UI”, is displayed adjacent to the digital ink. When selected, the confirmation UI is configured to display one or more selectable UI items corresponding to the recognition alternates. When selected, the selectable items will cause the text of the corresponding recognition alternate to be inserted into the document. For instance, the text may be inserted into a shape or into a text box. Selectable items may also be displayed for setting options relating to the display of the confirmation UI and for displaying a UI for correcting the digital ink.

It should be appreciated that the correction UI and the confirmation UI may each be utilized with shapes or with text. It should also be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a simplified computer architecture diagram showing aspects of an illustrative operating environment for the embodiments presented herein;

FIGS. 2A-5B are user interface diagrams illustrating aspects of the embodiments provided herein for converting digital ink to a shape;

FIGS. 6A-8D are user interface diagrams illustrating aspects of the embodiments provided herein for converting digital ink to text;

FIG. 9 is a flow diagram showing one illustrative routine disclosed herein for providing a user interface for converting digital ink to a shape;

FIG. 10 is a flow diagram showing one illustrative routine disclosed herein for providing a user interface for converting digital ink to text; and

FIG. 11 is a computer architecture diagram showing an illustrative computer hardware and software architecture for a computing system capable of implementing aspects of the embodiments presented herein.

### DETAILED DESCRIPTION

The following detailed description is directed to technologies for converting digital ink to shapes and text. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements throughout the several figures, aspects of a computing system and methodology for converting digital ink to shapes and text will be described.

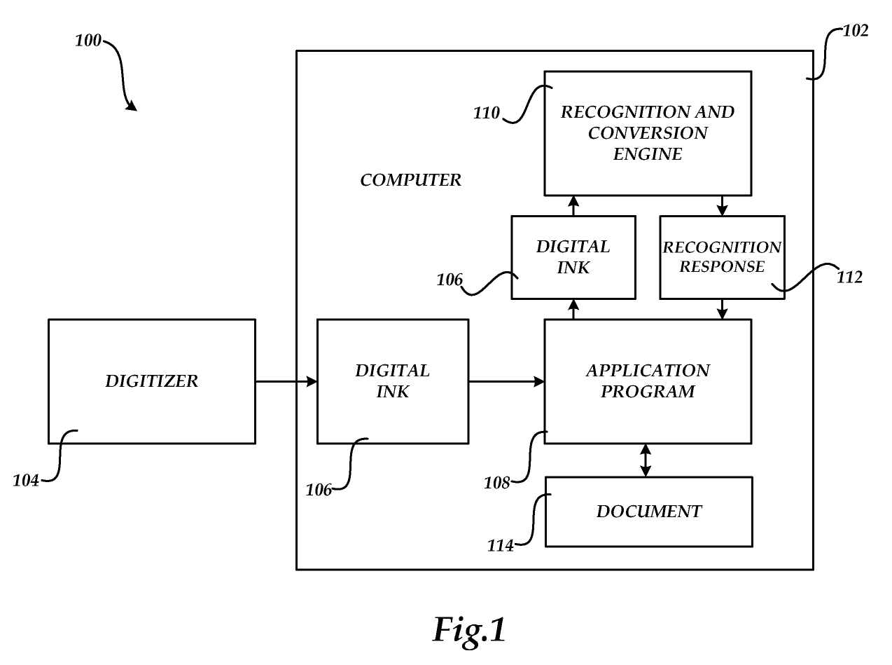

Turning now to FIG. 1, details will be provided regarding an illustrative operating environment and several software components provided by the embodiments presented herein. In particular, FIG. 1 shows aspects of a system 100 for converting digital ink to shapes and text. As shown in FIG. 1, the system 100 includes a computer 102 equipped with a digitizer 104 through which a user may provide digital ink 106. As discussed above, the digitizer 104 may comprise a pointing device like a mouse, a digitizer tablet, or a display screen integrated with the digitizer tablet like a touch sensitive display screen. The digitizer 104 may be integrated with the computer 102 or may be an external add-on device. It should be appreciated that the embodiments presented herein may be utilized with any type of computing system that is equipped with a digitizer 104 and appropriate software for performing the functionality presented herein.

As also described briefly above, the term digital ink as utilized herein refers to one or more strokes that are recorded from the digitizer 104. For instance, according to embodiments, the digitizer 104 may provide a stream of data generated in response to user interaction with the digitizer 104. The stream of data may be formatted as digital ink 106 provided to an operating system of the computer 102 or an application program 108. Through the use of the digitizer 104, the user can draw shapes and text in a manner similar to using traditional writing methods. As will be described in greater detail below, the embodiments presented herein allow a user to draw a freeform shape utilizing the digitizer 104. In response to receiving digital ink 106 in the form of a shape, a recognition and conversion engine 110 is utilized to recognize the shape and to provide a beautified shape for insertion into the document 114. As used herein, the term “beautified shape” refers to the geometrically correct representation of a shape drawn by hand utilizing the digitizer 104.

As shown in FIG. 1, the application program 108 receives digital ink 106 from the digitizer 104. In response thereto, the digital ink 106 is provided to the recognition and conversion engine 110. The recognition and conversion engine 110 recognizes shapes contained within the digital ink and returns a recognition response 112 to the application program 108. According to implementations, the recognition response 112 may include one or more strokes contained within the digital ink 106, a beautified shape if a shape is recognized in the digital ink 106, and the name of the recognized shape. When ambiguity exists in the digital ink 106 regarding the shape defined therein, the recognition and conversion engine 110 may return a recognition response 112 that identifies two or more beautified shapes.

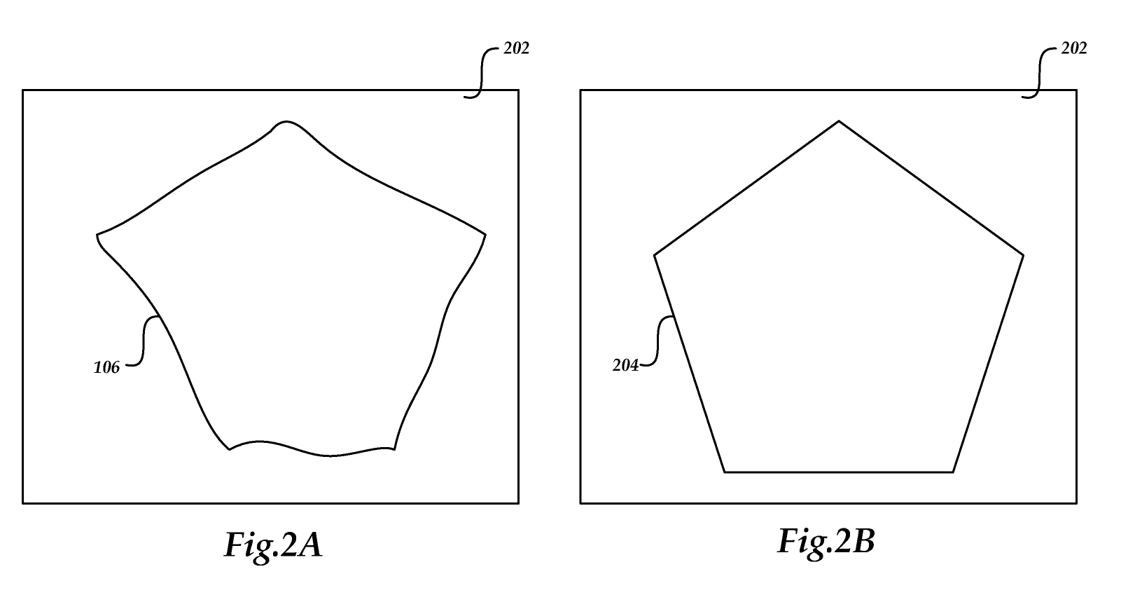

As will be described in greater detail below, the application program 108 receives the recognition response 112 from the recognition and conversion engine 110. In response thereto, the application program 108 inserts the beautified shape into the document 114. The application program 108 then provides a user interface control for modifying the beautified shape that has been inserted into the document 114. For instance, the user interface control described herein may allow a user to undo the insertion of the beautified shape into the document 114, delete the beautified shape, or apply formatting to the beautified shape inserted into the document 114. Additionally details regarding this user interface will be provided below with respect to FIGS. 2A-5B.

According to another implementation, the digital ink 106 may include text expressed using handwriting or block lettering. In response to receiving digital ink 106 that includes text, the recognition and conversion engine 110 identifies the text expressed in the digital ink 106 and provides a recognition response 112 that includes the text. When ambiguity exists, two or more recognition alternates corresponding to the text contained in the digital ink 106 may be provided in the recognition response 112.

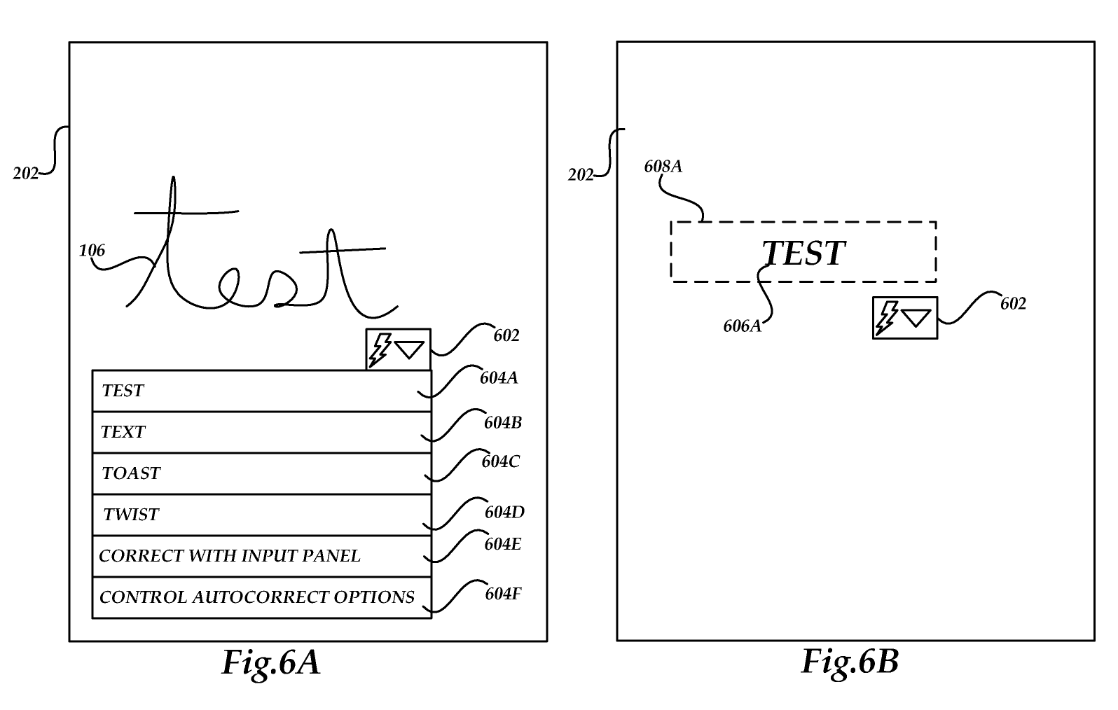

In response to receiving the recognition response 112 in this embodiment, the application program 108 is configured to provide a user interface through which a user can select the most appropriate recognition alternate for insertion into the document 114 as text. In response to receiving a selection of one of the recognition alternates, the selected text is inserted into the document 114 in a shape or in a text box. Additional details regarding this user interface will be provided below with respect to FIGS. 6A-8D and FIG. 10.

Referring now to FIGS. 2A-2B, additional details will be provided regarding the functionality provided by the application program 108 and the recognition and conversion engine 110 for converting digital ink 106 to a beautified shape.

As illustrated in FIGS. 2A-2B, the application program 108 is configured in one embodiment to provide a canvas 202 upon which a user can draw digital ink 106. As discussed above, the digital ink 106 may take the form of shapes, text, or arbitrary strokes generated by the user. In this embodiment, the application program 108 includes a mode of operation wherein shapes drawn in digital ink 106 will be converted to beautified shapes as the user completes them. In one implementation, this mode of operation is turned off by default and may be turned on through the selection of an appropriate user interface control provided by the application program 108.

When digital ink 106 is converted to a beautified shape 204, the beautified shape 204 is stored in a native application format utilized by the application program 108 for representing shapes. For instance, the beautified shape 204 may be stored in the same application format that is utilized to store shapes made available for insertion into the document 114 through a shape gallery or other type of user interface. In this manner, any operations that may be performed on shapes may also be performed on the beautified shape 204 inserted into the document 114 in the manner presented herein.

According to embodiments, the recognition and conversion engine 110 determines when shapes are complete and will identify the shape, or shapes if there is ambiguity, that the digital ink 106 corresponds to. In one implementation, the engine 110 will only consider a shape complete after a stroke has been completed, not in the middle of a stroke. According to other aspects, erasing or moving strokes may trigger automatic conversion if an edit of this type results in a completed shape.

Like stroke insertion, automatic conversion in response to erasing or moving strokes will only occur after the stroke has been completed. In most cases, existing digital ink strokes (i.e. strokes drawn before entering the automatic conversion mode) will not be automatically converted. However, if a partial shape is drawn while not in the automatic conversion mode and then completed when in an automatic conversion mode, it will be converted to a beautified shape 204.

For a set of strokes to be automatically converted, at least one stroke in the set must have been drawn in the automatic conversion mode. Strokes that have been grouped by the user, either with other digital ink strokes or with non-ink shapes, will not be automatically converted. If the engine 110 determines that a group of digital ink strokes may represent more than one type of shape, it will return a set of possible shapes along with a relative confidence level for each shape.

As discussed briefly above, in addition to a confidence level for each possible shape returned by the engine 110, the engine 110 will also return the beautified shape 204. As also mentioned briefly above, a beautified shape consists of the points in space that define the recognized shape. For example, a user of the digitizer 104 is unlikely to draw a perfect square. However, if the user draws something the engine 110 considers close enough to be a square, it will return a perfect square as the beautified shape in the recognition response 112.

According to embodiments, the recognition engine 110 supports recognition of the following geometric shapes: rectangle, square, diamond, parallelogram, trapezoid, irregular quadrilateral, regular pentagon, regular hexagon, ellipse, circle, line, single headed arrow, double headed arrow, right triangle, equilateral triangle, isosceles triangle, and irregular triangle. It should be appreciated that other types of shapes other than geometric shapes may also be recognized. For instance, flow chart shapes, lines, block lines, call outs, and virtually any other type of shape may be recognized by the recognition and conversion engine 110.

According to one embodiment, the shapes inserted based on the conversion of the digital ink 106 will not inherit properties of the digital ink 106, such as color and weight. Instead, shapes will follow a current default shape style. Digital ink 106 that is not recognized as any supported shape will be inserted into the document 114 as digital ink 106. In addition, in one embodiment digital ink 106 drawn over an existing shape 204 will convert to a new shape on top of the original. It will not replace the existing shape 204.

It should be appreciated that, according to embodiments, the application program 108 may support an immediate conversion mode wherein digital ink 106 is immediately converted to a shape. A second mode of operation, referred to here as the batch conversion mode, may also be provided. In the batch conversion mode, an entire diagram may be drawn consisting of multiple shapes. When the complete diagram has been drawn, a user may select the batch conversion mode of operation for converting all of the shapes in the diagram at once. It should be appreciated that the embodiments presented herein operate similarly in either of these modes of operation.

According to one embodiment, when the application program 108 is operating in the immediate conversion mode, digital ink insertion and shape conversion are placed onto an undo stack as two separate events. After the digital ink 106 is converted to a shape, requesting an undo operation one time will remove the shape 204 and revert to the digital ink 106. Requesting an undo operation a second time will remove the digital ink 106 from the canvas 202. In one embodiment, undo and redo operations are the only way to convert back and forth between a shape 204 and the digital ink 106 it was converted from. After conversion, shapes will retain no information about the digital ink they were converted from.

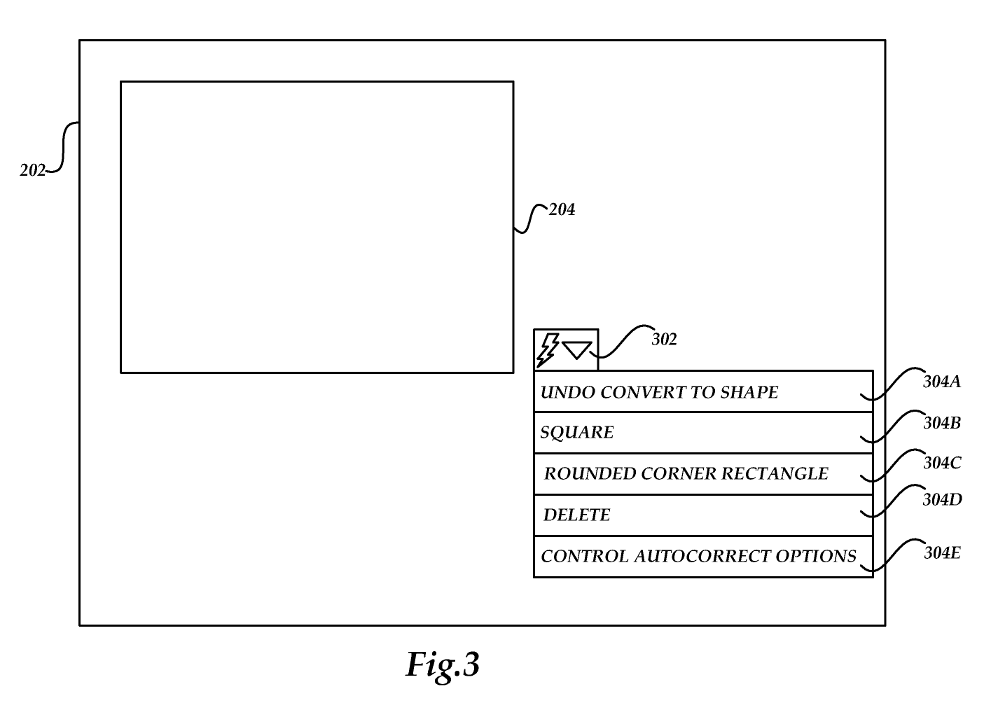

Referring now to FIG. 3, additional detail will be provided regarding one user interface provided by the application program 108 for inserting the digital ink 106 into a document 114 in the form of a shape 204. As discussed briefly above, when a user utilizes the digitizer 104 to draw digital ink 106 in the form of a shape, the recognition and conversion engine 110 recognizes the shape and returns a beautified shape to the application program 108.

In one embodiment, the beautified shape 204 is inserted onto the canvas 202 immediately following recognition. In this embodiment, the application program 108 is configured to display a user interface control 302 adjacent to the recognized shape 204. When selected, the user interface control 302 will display a number of selectable items 304A-304E. As will be described in greater detail below, the selectable items 304A-304E allow a user to select a different shape for insertion onto the canvas 202, undo the insertion of the shape 204 onto the canvas 202, delete the shape 204 from the canvas 202, and to specify options regarding when and how the user interface control 302 is displayed by the application program 108. Additional details regarding these operations are provided below.

As illustrated in FIG. 3, the selection of the item 304A will cause an undo operation to be performed wherein the digital ink 106 is inserted onto the canvas 202 in place of the shape 204. As described above, a second undo operation may be performed to remove the digital ink 106 from the canvas 202. Selection of the item 304D will cause the shape 204 to be deleted from the canvas 202. It should be appreciated that the insertion of a shape 204 onto the canvas 202 causes the shape 204 to be inserted into the document 114. Similarly, removal of the shape 204 from the canvas 202 causes the shape 204 to be similarly removed from the document 114.

According to embodiments, one or more of the selectable items 304A-304E may also allow a user to choose a different shape for insertion onto the canvas 202. As discussed briefly above, when ambiguity exists within the digital ink 106, the engine 110 may return multiple beautified shapes and a confidence level for each. In this case, the beautified shape with the highest confidence level is inserted onto the canvas 202. Other possible shapes may then be identified by one or more of the selectable items 304A-304E. When selected, the shape corresponding to the selected item will be inserted onto the canvas 202 in place of the originally inserted shape 204. For instance, in the example shown in FIG. 3, a beautified shape 204 corresponding to a rectangle has been inserted onto the canvas 202. However, because ambiguity exists in the digital ink 106 from which the shape 204 was recognized, a selectable item 304B has been displayed corresponding to a square. If a user selects the item 304B, a square will be inserted onto the canvas 202 in place of the rectangle that was previously inserted. It should be appreciated that any number of other shapes may be identified and inserted onto the canvas 202 in this manner.

It should also be appreciated that, according to embodiments, one or more of the selectable items 304A-304E may be utilized to change formatting of the shape 204 inserted onto the canvas 202. For instance, in the embodiment shown in FIG. 3, an item 304C has been provided for applying formatting to the shape 204 that will round the corners of the recognized rectangle. It should be appreciated that other types of formatting options may be made available through the selectable items 304 and applied to the shape 204.

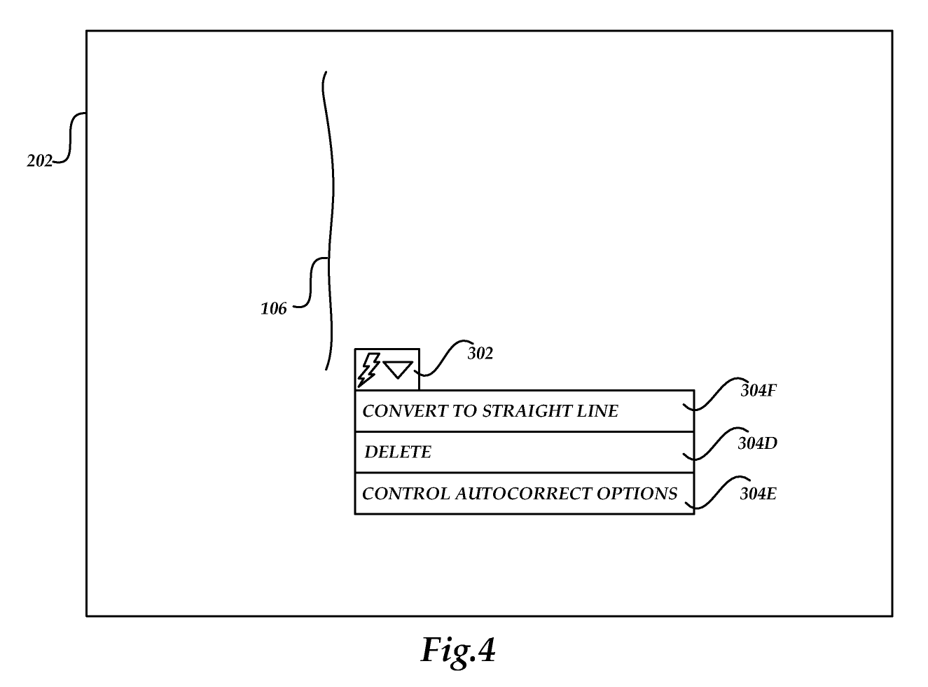

Referring now to FIG. 4, additional details regarding the embodiments presented herein with respect to the recognition of straight lines will be described. As shown in FIG. 4, digital ink 106 has been drawn on the canvas 202 in the form of an approximately straight line. Because a single straight line without an arrow head is a precursor to recognition of all of the polygons supported by the engine 110, such a line cannot be converted immediately.

In order to recognize when a user intends to drawn a straight line, the user interface 302 is displayed immediately upon recognizing a hand drawn line that is sufficiently straight and that does not have an arrow head. For instance, in the example shown in FIG. 4, the user interface control 302 has been displayed adjacent to the digital ink 106. As shown in FIG. 4, selection of the user interface control 302 results in the display of the selectable items 304F-304E. As shown in FIG. 4, the item 304 corresponds to an action for converting the digital ink 106 into a beautified straight line shape. A item 304D is also provided for deleting the digital ink 106. Another item 304E is also provided which, when selected, will provide an appropriate user interface for allowing a user to specify when and how the user interface control 302 is displayed. It should be appreciated that other selectable items 304 may be displayed in response to the detection of a sufficiently straight line without an arrowhead.

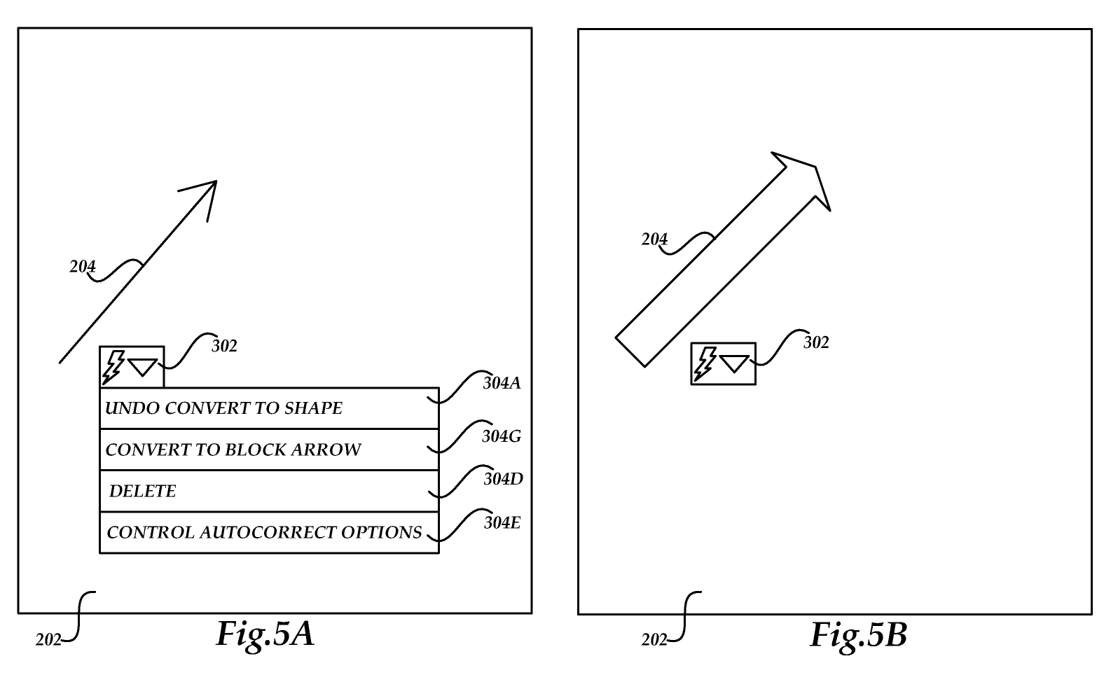

As discussed briefly above, certain types of formatting options are made available through the selectable items 304. FIGS. 5A-5B illustrate another example of the type of formatting that may be applied to a recognized shape 204 in one embodiment. As shown in FIG. 5A, a user has drawn digital ink 106 in the form of an arrow that has been recognized by the engine 110. As a result, the shape 204 has been inserted onto the canvas 202 and the user interface 302 has been displayed adjacent thereto. In response to the selection of the user interface control 302 shown in FIG. 5A, the selectable items 304A, 304G, 304D, and 304E have been displayed. The items 304A, 304D, and 304E provide the functionality described above for undoing the insertion of the shape 204, deleting the shape 204, and setting options with respect to the display of the user interface control 302, respectively.

The selectable item 304G shown in FIG. 5A provides functionality for applying formatting to the shape 204. In this example, the item 304G provides functionality for converting the straight line arrow 204 to a block arrow shape. FIG. 5B shows the configuration of the shape 204 on the canvas 202 after selection of the item 304G. The user interface control 302 has also been displayed in the example shown in FIG. 5B. Selection of the user interface control 302 in this example may also provide functionality for undoing the formatting applied to the shape, deleting the shape 204, and specifying options. It should be appreciated that the examples of formatting that may be applied to a shape on the canvas 202 through the selection of the selectable items 304 are merely illustrative and that other types of formatting may be applied in a similar manner.

Referring now to FIG. 6A-6B, details will be provided regarding several embodiments presented herein for inserting digital ink into the document 114 as text. Unlike the shapes described above, digital ink 106 inserted onto the canvas 202 that specifies text is not automatically converted. Rather, when the engine 110 detects digital ink 106 that includes text, a user interface control 602, referred to herein as the confirmation user interface, is displayed adjacent to the digital ink 106. As shown in FIG. 6A, when the UI control 602 is selected, the one or more selectable items 604A-604F are displayed. As also shown in FIG. 6A, some of the selectable items 604A-604D are utilized to specify the recognition alternates for the digital ink 106. As discussed above, the recognition alternates represent the various text words or phrases that might be represented by the digital ink 106. The engine 110 provides functionality for identifying the recognition alternates when there is ambiguity in the digital ink 106.

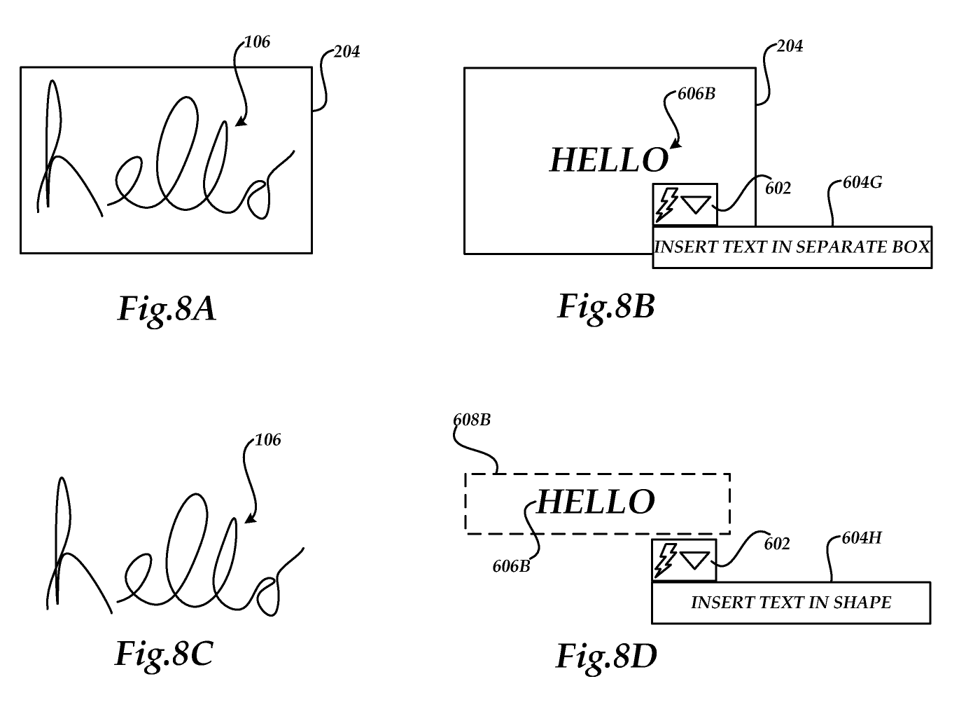

When selected, the selectable items 604A-604D will cause the text of the corresponding recognition alternate to be inserted onto the canvas 202. For instance, as shown in FIG. 6B, a user has selected the item 604A. This causes the text 606A to be inserted onto the canvas 202 in a text box 608A. A user interface control 602 may be displayed adjacent to the text box for specifying the manner in which the text 606A is inserted into the document 114. Additional details regarding this user interface are provided below with respect to FIGS. 8B and 8D.

As shown in FIG. 6A, selection of the user interface control 602 also causes an item 604E to be displayed. When selected, the item 604E will cause an input panel to be displayed through which a user of the computer 102 can correct the digital ink 106. A selectable item 604F is also displayed which, when selected, will provide an appropriate user interface for a user to specify options relating the user interface control 602, such as when and how the user interface control 602 is displayed.

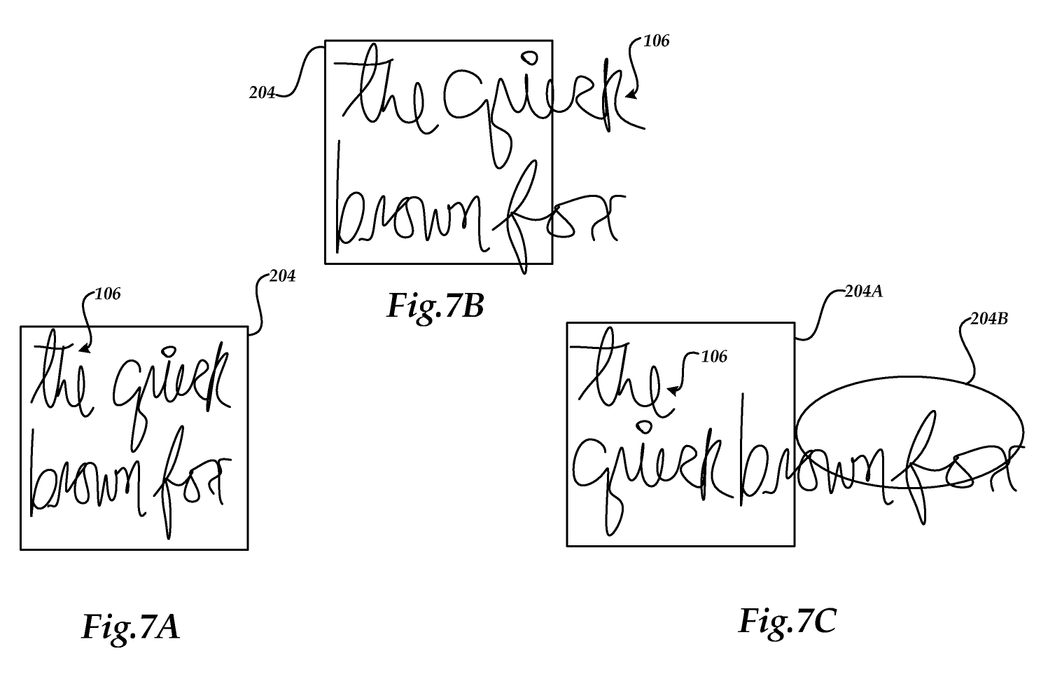

According to embodiments, the engine 110 is further configured to recognize when a user is requesting that digital ink 106 be associated with a shape. FIGS. 7A-7C illustrate aspects of this process. For instance, in the example shown in FIG. 7A, a user has generated digital ink 106 that is completely within a shape 204. In this example, the shape's text is set to the recognition results from the digital ink 106.

In the example shown in FIG. 7B, the majority of the digital ink 106 overlaps the shape 204. In this case, the recognition results from the digital ink 106 are also utilized to set the text for the shape 204. If, however, the majority of the digital ink 106 was outside of the shape 204, the recognition results from the digital ink 106 would be inserted into a new text box. In the example shown in FIG. 7C, the digital ink 106 overlaps two shapes 204A and 204B. In this example, if a single shape 204A contains the majority of the digital ink 106, the text for that shape is set to the recognition result return from the conversion engine 110. If neither of the shapes 204A-204B contains a majority of the digital ink 106, a new text box containing the recognition results will be generated.

In the example shown in FIGS. 8A-8B, digital ink 106 has been generated that is completely within the shape 204. Because the digital ink 106 is completely within the shape 204, the text 606B has been inserted as the text for the shape 204. In this example, a user interface 602 has been presented that includes one selectable item 604G. When selected, the item 604G will cause the text 606B that has been inserted into the shape 204 to be added to the canvas 202 in a separate text box 608. In this manner, a user can easily cause text 606B that was inserted into a shape 204 to be moved from the shape 204 into a separate text box 608. It should be appreciated that selection of the user interface control 602 shown in FIG. 8B may also cause other selectable items for performing other functions with respect to the text 606B to be displayed.

In the example illustrated in FIG. 8C-8D, digital ink 106 has been placed on the canvas 202 that is not within or adjacent to any shape. In this example, the text 606B has been inserted onto the canvas 202 within a text box 608B. In response thereto, the user interface control 602 has been displayed adjacent to the text box 608B. When selected, the user interface control 608 shown in FIG. 8D will cause the selectable item 604H to be displayed. In this example, the item 604H provides functionality for inserting the text 606B into a shape. In this way, a user can easily move text from a text box 608B into a shape 204 on the canvas 202. Other selectable items may be provided in response to the selection of the user interface control 602 shown in FIG. 8D.

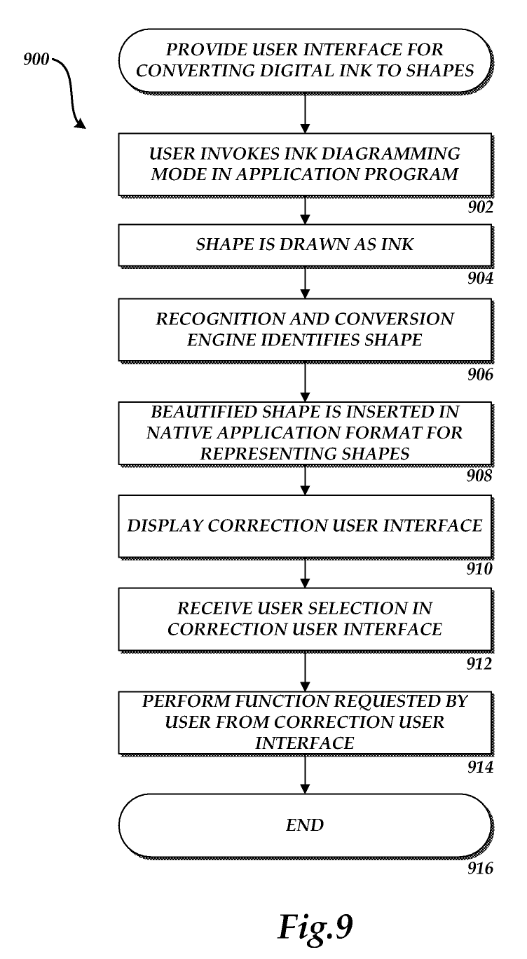

Referring now to FIG. 9, additional details will be provided regarding the embodiments presented herein for converting digital ink to shapes and text. In particular, FIG. 9 is a flow diagram showing one illustrative routine 900 for providing a user interface for converting digital ink to a shape in one embodiment.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 900 begins at operation 902, where a user invokes an ink diagramming mode in the application program 108. As discussed above, the ink diagramming mode allows a user to utilize the digitizer 104 to draw shapes and to have the shapes inserted into the document 114. As also discussed above, the ink diagramming mode may operate in an immediate conversion mode wherein shapes are converted immediately or in a batch conversion mode wherein multiple shapes may be converted by the recognition and conversion engine at one time.

Once the ink diagramming mode has been entered, a user may utilize the digitizer 104 to draw digital ink 106 in the form of a shape. This occurs at operation 904. In response to receiving the digital ink 106, the application program 108 provides the digital ink 106 to the recognition and conversion engine 110. At operation 906, the recognition and conversion engine 110 recognizes the shape, or shapes, specified by the digital ink 106 and returns the recognition response 112 to the application program 108. As discussed above, the recognition response 112 includes the strokes contained within the digital ink 106, one or more beautified shapes, and the names of the beautified shapes.

From operation 906, the routine 900 proceeds to operation 908, where the beautified shape returned by the recognition and conversion engine 110 is inserted into the document 114. As discussed above, the shape is inserted into the document 114 in the same native application format utilized by the application program 108 for representing other types of shapes. It should be appreciated that the native application format may include certain data structures or object formats, common to all shapes.

Once the new shape 204 has been inserted into the document 114, the application program 108 displays the correction user interface 302 described above. This occurs at operation 910. If user input is received selecting the user interface control 302, the selectable items 304 described above are displayed. As discussed above, the particular selectable items that are displayed may be dependent upon the type of shape that is recognized and inserted into the document 114.

Once the selectable items 304 have been displayed, a user may select one of the selectable items 304. In response to such a selection, the function corresponding to the selected item is performed by the application program 108. This occurs at operation 914. For instance, as described above, an undo operation may be performed on the shape 204, the shape 204 may be deleted, formatting may be applied to the shape 204, another shape may be inserted in place of the shape 204, and options may be specified with respect to the display of the user interface control 302. Other options may be invoked by the selection of one of the selectable items 304. From operation 914, the routine 900 proceeds to operation 916, where it ends.

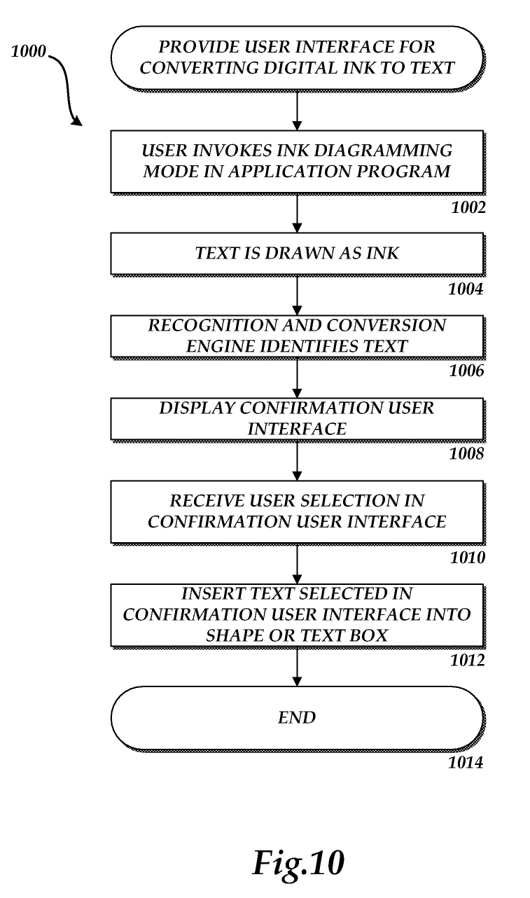

Referring now to FIG. 10, an illustrative routine 1000 will be described that illustrates operations performed by the application program 108 in one embodiment for inserting digital ink 106 into a document 114 as text. The routine 1000 begins at operation 1002, where a user of the computer 102 invokes the ink diagramming mode of the application program 108. The routine 1000 then proceeds to operation 1004 where digital ink 106 is drawn using the digitizer 104 that corresponds to handwritten or block text. From operation 1004, the routine 1000 proceeds to operation 1006, where the recognition and conversion engine 110 recognizes the text within the digital ink 106 and returns the recognition alternates to the application program 108.

From operation 1006, the routine 1000 proceeds to operation 1008 where the application program 108 displays the confirmation user interface control 602 described above. In response to the selection of the confirmation user interface control 602, the selectable items 604 are displayed.

From operation 1008, the routine 1000 proceeds to operation 1010 where a user may select one of the selectable items 604. As discussed above, several of the selectable items 604 may correspond to the recognition alternates. If a user selects one of these selectable items, the text corresponding to the selected item will be inserted into the document 114 in either a shape or within a text box 608. In a similar manner, a user may select a selectable item for correcting the digital ink 106 with a user input panel and for displaying a user interface for specifying options relating to the manner in which the user interface control 602 is displayed. From operation 1012, the routine 1000 proceeds to operation 1014, where it ends.

It should be appreciated that the confirmation user interface control 602 may also be utilized with shapes. As an example, when a shape is drawn using digital ink, the user interface control 602 may be utilized to provide a menu of possible shapes identified by the recognition and conversion engine 110 as recognition candidates. A menu item may then be selected in order to convert the digital ink into a selected shape. Similarly, the correction UI 302 might be utilized with handwritten text. In this implementation, the handwritten text might automatically be converted to typeset text. The UI control 302 could then be displayed for providing the correction options presented above.

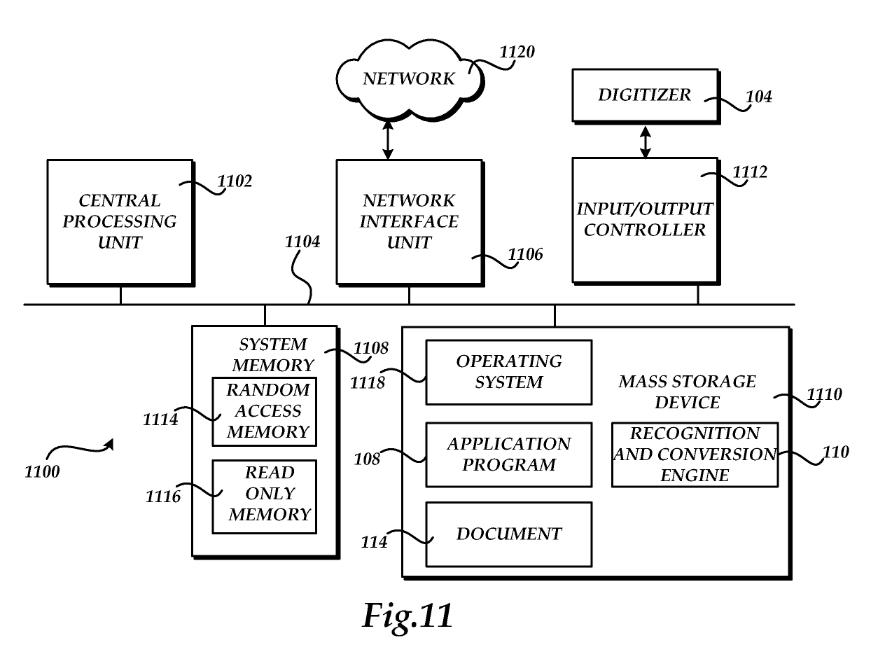

FIG. 11 shows an illustrative computer architecture for a computer 1100 capable of executing the software components described herein for converting digital ink to shapes and text in the manner presented above. The computer architecture shown in FIG. 11 illustrates a conventional desktop, laptop, or server computer and may be utilized to execute any aspects of the software components presented herein described as executing on the computer 102.

The computer architecture shown in FIG. 11 includes a central processing unit 1102 (“CPU”), a system memory 1108, including a random access memory 1114 (“RAM”) and a read-only memory (“ROM”) 1116, and a system bus 1104 that couples the memory to the CPU 1102. A basic input/output system containing the basic routines that help to transfer information between elements within the computer 1100, such as during startup, is stored in the ROM 1116. The computer 1100 further includes a mass storage device 1110 for storing an operating system 1118, application programs, and other program modules, which are described in greater detail herein.

The mass storage device 1110 is connected to the CPU 1102 through a mass storage controller (not shown) connected to the bus 1104. The mass storage device 1110 and its associated computer-readable media provide non-volatile storage for the computer 1100. Although the description of computer-readable media contained herein refers to a mass storage device, such as a hard disk or CD-ROM drive, it should be appreciated by those skilled in the art that computer-readable media can be any available computer storage media that can be accessed by the computer 1100.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 11100.

According to various embodiments, the computer 1100 may operate in a networked environment using logical connections to remote computers through a network such as the network 1120. The computer 1100 may connect to the network 1120 through a network interface unit 1106 connected to the bus 1104. It should be appreciated that the network interface unit 1106 may also be utilized to connect to other types of networks and remote computer systems. The computer 1100 may also include an input/output controller 1112 for receiving and processing input from a number of other devices, including a digitizer 104, such as a mouse, a digitizer tablet, or a display screen integrated with a digitizer tablet. Similarly, an input/output controller may provide output to a display screen, a printer, or other type of output device (also not shown in FIG. 11).

As mentioned briefly above, a number of program modules and data files may be stored in the mass storage device 1110 and RAM 1114 of the computer 1100, including an operating system 1118 suitable for controlling the operation of a networked desktop, laptop, or server computer. The mass storage device 1110 and RAM 1114 may also store one or more program modules. In particular, the mass storage device 1110 and the RAM 1114 may store the application program 108, the recognition and conversion engine 110, and the document 114, each of which was described in detail above with respect to FIGS. 1-10. The mass storage device 1110 and the RAM 1114 may also store other types of program modules.

Based on the foregoing, it should be appreciated that technologies for converting digital ink to shapes and text are provided herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-readable medium having computer executable instructions stored thereon which, when executed by a computer, cause the computer to:
receive digital ink for insertion into a document;
insert the digital ink into the document;
display the digital ink;
provide the digital ink to a recognition engine;
receive a recognized shape corresponding to the digital ink from the recognition engine;
select a beautified shape expressed in a native document format based on the recognized shape;
insert the beautified shape into the document in place of the digital ink and to display the beautified shape;
display a user interface control adjacent to the beautified shape;
receive a selection of the user interface control; and to
display one or more selectable items in response to receiving the selection of the user interface control which, when selected, will modify the beautified shape.

2. The computer-readable medium of claim 1, wherein two or more recognized shapes corresponding to the digital ink are identified by the recognition engine, and wherein two or more of the selectable items correspond to the two or more recognized shapes and which, when selected, will cause a corresponding beautified shape expressed in a native document format to be inserted into the document.

3. The computer-readable medium of claim 2, wherein one of the selectable items comprises an item which, when selected, will cause the digital ink to be re-inserted into the document in place of the beautified shape.

4. The computer-readable medium of claim 2, wherein one of the selectable items comprises an item which, when selected, will cause the beautified shape to be deleted.

5. The computer-readable medium of claim 2, wherein the beautified shape comprises a square, and wherein one of the selectable items comprises an item which, when selected, will cause the corners of the square to be rounded.

6. The computer-readable medium of claim 2, wherein the beautified shape comprises a rectangle, and wherein one of the selectable items comprises an item which, when selected, will cause the corners of the rectangle to be rounded.

7. The computer-readable medium of claim 2, wherein the beautified shape comprises a straight line arrow, and wherein one of the selectable items comprises an item which, when selected, will cause the straight line arrow to be replaced with a block arrow.

8. The computer-readable medium of claim 2, wherein one of the selectable items comprises an item which, when selected, will cause a user interface to be provided for setting one or more options relating to the user interface control.

9. A computer-readable medium having computer executable instructions stored thereon which, when executed by a computer, cause the computer to:
receive digital ink for insertion into a document;
insert the digital ink into the document;
display the digital ink;
provide the digital ink to a recognition engine;
receive two or more recognition alternates corresponding to the digital ink from the recognition engine; and to
display a user interface control adjacent to the digital ink which, when selected, will display one or more selectable items, each of the selectable items corresponding to one of the recognition alternates and which, when selected, will cause the corresponding recognition alternate to be inserted into the document as text.

10. The computer-readable medium of claim 9, comprising further computer executable instructions which, when executed by the computer, will cause the computer to:
receive a selection of one of the selectable items; and to
insert the text recognition alternate corresponding to the selected item into the document as text.

11. The computer-readable medium of claim 10, wherein the text is inserted into a shape in the document.

12. The computer-readable medium of claim 11, wherein the text is inserted into a text box in the document.

13. The computer-readable medium of claim 9, wherein one of the selectable items comprises an item which, when selected, will cause a user interface to be provided for setting one or more options relating to the user interface control.

14. The computer-readable medium of claim 9, wherein one of the selectable items comprises an item which, when selected, will cause a user interface to be provided for correcting the digital ink.

15. A computer-implemented method for inserting digital ink into a document on a computer having a digitizer, the method comprising executing computer-implemented operations on the computer for:
receiving digital ink for insertion into a document from the digitizer;
inserting the digital ink into the document at the computer;
transforming the digital ink for display at the computer;
provide the digital ink to a recognition engine executing at the computer;
receive a recognized shape corresponding to the digital ink or two or more recognition alternates corresponding to the digital ink from the recognition engine;
in response to receiving the recognized shape from the recognition engine, identifying a beautified shape based on the recognized shape, inserting the beautified shape into the document in place of the digital ink and to display the beautified shape, displaying a first user interface control adjacent to the beautified shape, receiving a selection of the first user interface control and display one or more selectable items in response to receiving the selection of the first user interface control which, when selected, will modify the beautified shape; and
in response to receiving the recognition alternates from the recognition engine, displaying a second user interface control adjacent to the digital ink which, when selected, will display one or more selectable items, each of the selectable items corresponding to one of the recognition alternates and which, when selected, will cause the corresponding recognition alternate to be inserted into the document as text.

16. The method of claim 15, wherein the beautified shape is stored in a native application format for representing shapes.

17. The method of claim 16, wherein two or more beautified shapes corresponding to the digital ink are received from the recognition engine, and wherein two or more of the selectable items correspond to the two or more beautified shapes and which, when selected, will cause the corresponding beautified shape to be inserted into the document.

18. The method of claim 17, further comprising:
receive a selection of one of the selectable items displayed in response to the selection of the second user interface control; and to
insert the text recognition alternate corresponding to the selected item into the document as text.

19. The method of claim 18, wherein one of the selectable items comprises an item which, when selected, will cause the digital ink to be re-inserted into the document in place of the beautified shape.

20. The method of claim 19, wherein one of the selectable items comprises an item which, when selected, will cause the beautified shape to be deleted.
